(19) United States
(12) Patent Application Publication
(10) Pub. No.: US 2025/0094628 A1
(43) Pub. Date: Mar. 20, 2025

(54) System and Method for Automated Generation of Access Descriptions for Identity Governance and Administration (IGA)

(71) Applicant: SailPoint Technologies, Inc., Austin, TX (US)

(72) Inventors: Tyler McDonnell, Austin, TX (US); Mohamed M. Badawy, Round Rock, TX (US); Quoc Co Tran, Houston, TX (US); Kelly Grizzle, Austin, TX (US); Sana Amin Rajani, Cincinnati, OH (US)

(21) Appl. No.: 18/888,709

(22) Filed: Sep. 18, 2024

Related U.S. Application Data
(60) Provisional application No. 63/583,456, filed on Sep. 18, 2023.

(51) Int. Cl. G06F 21/62

(52) U.S. Cl. CPC G06F 21/6245

(57) ABSTRACT

Systems and methods are disclosed relating to identity governance. Embodiments relate to the use of large language models (LLMs) to produce rich, accurate human readable descriptions for access entitlements spanning identities, entitlements, and roles. The disclosed systems and methods give LLMs the unique ability to generate highly relevant descriptions of these access items, based on various information, e.g., entitlement name, related application(s) name/type, attributes of identities, related business roles, other metadata, etc. The automatically generated descriptions enable more clarity regarding applications, roles, entitlements, etc., and drive an improvement in customer utilization of identity governance products.

### CROSS-REFERENCE TO RELATED APPLICATION(S)

This application claims a benefit of priority under 35 U.S.C. § 119(e) from U.S. Provisional Application No. 63/583,456, filed Sep. 18, 2023, entitled “SYSTEM AND METHOD FOR AUTOMATED GENERATION OF ACCESS DESCRIPTIONS FOR IDENTITY GOVERNANCE AND ADMINISTRATION (IGA),” which is fully incorporated by reference herein for all purposes.

### TECHNICAL FIELD

This invention relates to the field of data privacy and data protection and data governance regulation, and specifically to the field of identity governance and administration.

### BACKGROUND

In identity governance and administration/Identity and Access Management (IGA/IAM), entitlement-based access models enable users to define and manage access at the most granular level allowed by an application. Organizations may utilize entitlements and IT-service roles (bundled entitlements from the same application) as building blocks to construct complex business role structures that represent actual job functions within the organization. One common issue impacting the interpretability of these larger roles arises when the information describing the permissible actions of access items (e.g., entitlements, IT roles) is missing.

A human readable picture of access spanning identities, entitlements, and roles can be crucial to successful identity governance, but is difficult to achieve. There is no existing solution for creating this, other than manual labor. Subject matter expertise is required to provide accurate and meaningful descriptions. Utilizing human subject matter expertise is cost-prohibitive and unscalable due to the large number of entitlements (e.g., possibly tens or hundreds of thousands on average in mid-size organizations). As an example, it may be observed that 64% of access entitlement descriptions are left empty, and even when users do provide descriptions, they often lack the needed subject matter expertise on each access entitlement to produce accurate and meaningful descriptions. Lack of these descriptions makes it harder to interpret, manage, or certify larger business roles.

### SUMMARY

An automated access description generation system includes a processor and a non-transitory, computer-readable storage medium. The computer-readable storage medium includes computer instructions for: receiving a request to generate a description for an access entitlement in an identity governance and administration, providing a prompt to a large language models (LLM), the prompt specifying one or more rules for the LLM to follow when generating the description for the access entitlement, generating the description of the access entitlement using the LLM, and presenting, over a graphical user interface, the generated description of the access entitlement.

Embodiments of the present invention may also include computer-readable storage media containing sets of instructions to cause one or more processors to perform the methods, variations of the methods, and other operations described herein.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE FIGURES

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 is a block diagram depicting the implementation of a system for the automated generation of access descriptions according to one embodiment.

FIG. 2 is a block diagram depicting the implementation of a system for the automated generation of access descriptions including a knowledge base.

FIG. 3 is a block diagram depicting the implementation of a system for the automated generation of access descriptions including a feedback loop.

FIGS. 4A, 4B, and 4C are flowcharts depicting exemplary processes for the automated generation of access descriptions.

FIG. 5 is an example of a computer system that may be used in some embodiments of the present technology.

### DESCRIPTION

The invention and the various features and advantageous details thereof are explained more fully with reference to the non-limiting embodiments that are illustrated in the accompanying drawings and detailed in the following description and Appendix. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions and/or rearrangements within the spirit and/or scope of the underlying inventive concept will become apparent to those skilled in the art from this disclosure.

Generally, this disclosure covers the use of large language models (LLMs) to produce rich, accurate human readable descriptions for access entitlements spanning identities, entitlements, and roles. An LLM is a type of artificial intelligence (AI) model designed to understand and generate human language text, as one skilled in the art would understand. LLMs are generative machine learning (ML) language models that have been trained on a vast corpus of data, which may include online documentation of enterprise applications, technical manuals, online support forum postings, Q&A web sites, etc. In the context of automatically generating entitlement descriptions in an IGA/IAM environment, this gives LLMs the unique ability to generate highly relevant descriptions of these access items, based on some other available information, e.g., entitlement name, related application(s) name/type, attributes of identities, related business roles, other metadata, etc. Providing these automatically generated descriptions will enable more clarity regarding applications, roles, entitlements, etc., and will drive an improvement in customer utilization of identity governance products.

In the example below (Table 1), the human-generated description (center column) simply restates the information in the entitlement name, while the LLM-generated description provides an overview of what capabilities are available in Navex and those accessible with this entitlement. Additionally, LLMs may be used to aggregate, summarize, and translate the outputs of other models in a system (e.g., auto role mining, outlier detection, etc.) and effectively communicate those to humans through customized dashboards, messages, or recommended actions.

TABLE 1

| | Human-Generated | |
|---|---|---|
| Entitlement | Description | LLM-Generated Description |
| SSO - | This allows access to the Navex | This entitlement grants user-level access to Navex |
| Navex User | app | Global's compliance and risk management software |
| | | through Single Sign-On. Navex provides tools for |
| | | compliance management, risk management, and |
| | | ethics training. A user has the ability to log into |
| | | Navex, view and interact with compliance and risk |
| | | management data, policies, and training materials. |

One aspect of this disclosure relates to fine tuning the LLM to produce adequate performance for this task. Fine-tuning can be performed with carefully engineered and proprietary (in one example) training data consisting of {input: output}pairs for the model to learn. For example, in the exemplary case of generating entitlement descriptions, the input may include information such as the string identifier (name) of the entitlement; the source application of the entitlement (e.g., Slack, Navex, Active Directory, etc.); the roles of users who have access to that entitlement in a system (e.g., engineer, account executive, etc.); activity data about usage of the entitlement; or other information about the patterns of access or characteristics of the entitlement that may be exclusively available to an identity governance manager. The output may consist of proprietary human-produced examples of ideal entitlement descriptions. These may be created specifically for the task (entitlement descriptions, role descriptions, etc.). The overall fine-tuning data may consist of hundreds or thousands of such {input: output}pairs. Note that, it is possible that, when using third party LLMs, the ability to fine tune, as discussed above, can be limited or restricted.

One aspect of this disclosure relates to prompts. In the context of machine learning models, a prompt may refer to an input or instruction provided to an AI model or system to perform a particular task or to generate a response. Prompts may be used to communicate with AI models and specify what kind of output or behavior is desired from them. The present disclosure may use carefully engineered prompting to deliver high quality results. The prompts may include a smaller subset of fine-tuning {input: output}examples, described above (when these are provided in the prompt itself, it's often called “in-context learning”). The prompts may specify, in a concise format, a number of specific rules for the LLM to follow when generating descriptions and qualities of the desired output. For example, the prompt may specify that the output should be of a certain length, written in a certain tone (e.g., confident), define relevant acronyms in the entitlement, provide a description of the source system, identify what specific capabilities the user will have with this access; etc. Other examples are also possible, as one skilled in the art would understand. The prompts may include a batch of inputs (see the above exemplary description) for which the model must generate descriptions. A designer may define a range of prompts for a single task to provide configurability or tunability to users. For example, shorter vs. longer descriptions could be produced, more technical vs. less technical descriptions could be produced, or multiple descriptions could be produced so that a user can select the best or generate alternatives on demand.

A system utilizing the disclosed techniques, using real data, will show that these carefully fine-tuned and prompted LLMs produce better-than-human descriptions, automatically and at scale.

Advantages of the disclosed systems include an automated system, whereas no automated solutions exist today. With traditional systems, users create descriptions manually, or not at all. For example, it is estimated that, in traditional systems, 64% of the 45 million plus entitlements are empty today (i.e., no description exists for a given entitlement). Even optimistically assuming that it would take 10 seconds of manual work per entitlement, automatically generating descriptions using the disclosed techniques represents savings of more than 100,000 hours of manual labor across various implementations of IGAs.

Another advantage relates to the quality of descriptions. LLMs have vast subject matter expertise because of being trained on large amounts of data. They can generate rich descriptions of an entitlement, e.g., that define obscure acronyms or provide detailed descriptions of the access. In contrast, humans typically lack broad subject matter expertise, so their manually generated descriptions may be short and vague.

One challenge with respect to LLMs relates to the robustness and stability of the LLMs. LLMs may exhibit instability and lack of robustness (e.g., the same prompt/query yielding different responses). Ensuring that identical queries issued in quick succession yield consistent responses requires careful prompting and tuning of model parameters, such as “top p” and “temperature”, which regulate the randomness of an LLM.

In some embodiments, ensuring consistency between current and future results calls for tools that serve as a “long-term memory” for the LLM. Using standard or vector DBs in conjunction with a localized LLM to generate output embeddings can enable the measurement of closeness between current and prior queries/responses.

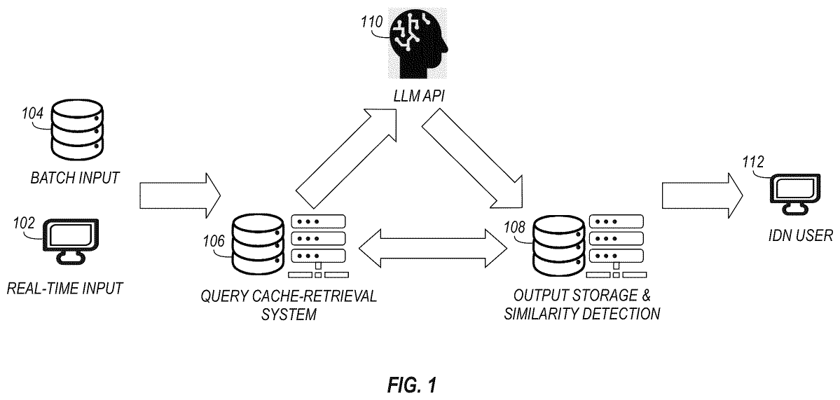

The system disclosed may be implemented in a number of ways, as one skilled in the art would understand. Following is one exemplary implementation, which is also illustrated in FIG. 1 below. In this example, two pipelines are used, corresponding to two potential use cases, real-time (“Real-time input 102” in FIG. 1), vs batch processing (“Batch input 104” in FIG. 1). For initial (e.g., during onboarding) and bulk requests, a batch processing pipeline may be a better fit. For example, when onboarding a new application that was not on the system before, the new application may have many different entitlements that need descriptions. For newly introduced applications/entitlements, a more real-time option may make more sense. For example, a user, via the system's UI (102), may be looking at a specific entitlement, and may request that the system generate a description of that entitlement. Generally, the LLM 110 is taking these requests and performing a similarity detection check against descriptions generated in response to previous requests. If something similar is found, it may incorporate that into the description, or just use the past description.

A query cache-retrieval system 106 enables detection of duplicate (and near duplicate) inputs, thus optimizing LLM queries and reducing costs. Generally, the query cache-retrieval system 106 is a database of descriptions generated in the past. By filtering out duplicate (and near duplicate) entity names or inputs, costs and resource usage can be optimized, for example, by optimizing the number of queries submitted to the LLM 110 without impacting the quality of the output. The same cache-retrieval system 106 can be used to collect user feedback/human annotations (e.g., did a user accept the recommended query, did they make modifications to it, etc.?). This collected feedback/human annotations can later be used to further fine-tune the model using additional training or in-context learning.

Output storage and similarity detection 108 enables detection of inconsistencies of LLMs (e.g., due to versioning) and measurement of the extent of such problems. Output storage and similarity detection 108 also enables optimization of direct LLM 110 queries by reusing previous responses for identical or near-identical inputs.

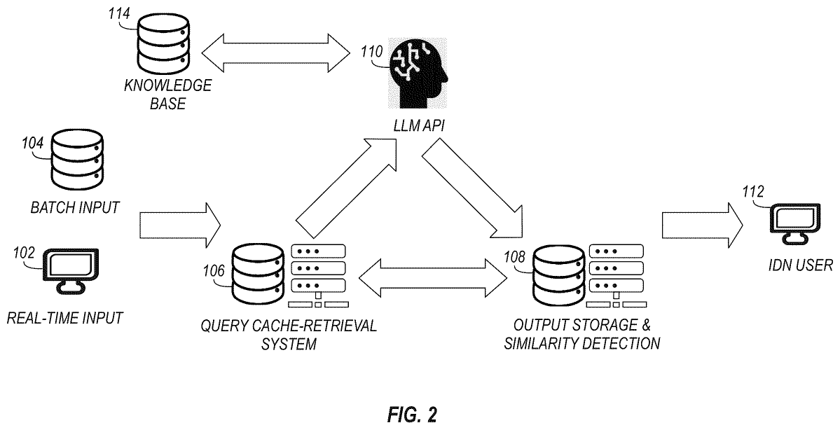

In some embodiments, the system may include a knowledge base 114 of information about a specific entitlement. FIG. 2 is a diagram of another exemplary implementation similar to FIG. 1, but with the addition of a knowledge base 114. So, in addition to having access to a history of previously generated descriptions (via the cache-retrieval system), the knowledge base 114 can provide information about a specific entitlement, including, for example, metadata (e.g., roles, organization specific information, industry specific information, etc.). Note that, in this embodiment, the knowledge base 114 is not part of the input data, but rather, helps the LLM 110 by providing context and additional information about a specific organization, industry, etc. For example, for applications in the medical field, the knowledge base 114 may provide contextual information such as medical terms, medical roles, drug or diagnostic information, clinical guidelines, etc. One advantage of the knowledge base 114 relates to data security. If the LLM 110 were trained using information about a specific organization, for example, that training data could surface later, potentially exposing the information. Supplementing the LLM 110 via the knowledge base 114 to a specific organization, prevents this, and allows the same LLM 110 to be trained and used by different entities (with different knowledge bases for each), without risk of information in the knowledge base 114 being exposed where not intended. In other words, the knowledge base 114 provides additional context that helps the LLM 110 solve its tasks in an optimal way, but without training the LLM 110 with the additional information to address security concerns.

In some embodiments, the system can include a feedback loop 116 to enable the user 112 to provide feedback to the knowledge base 114, to help improve the LLM 110. In some embodiments, the user 112 may be a reviewer tasked to review descriptions generated by the LLM 110. Note that the user 112 (e.g., a user of Sailpoint's IdentityNow, a cloud-based identify governance platform) could be the same user 102 providing real-time input, or could be a different user. In some embodiments, the user 112 is able to accept or modify the description generated by the LLM 110. This information can be provided as feedback to the knowledge base 114 via the feedback loop 116. The feedback information can then be incorporated into the knowledge base 114 to enable the knowledge base 114 to provide better information to the LLM 110. In another embodiment, another LLM or model can be tasked with taking the output and providing the feedback.

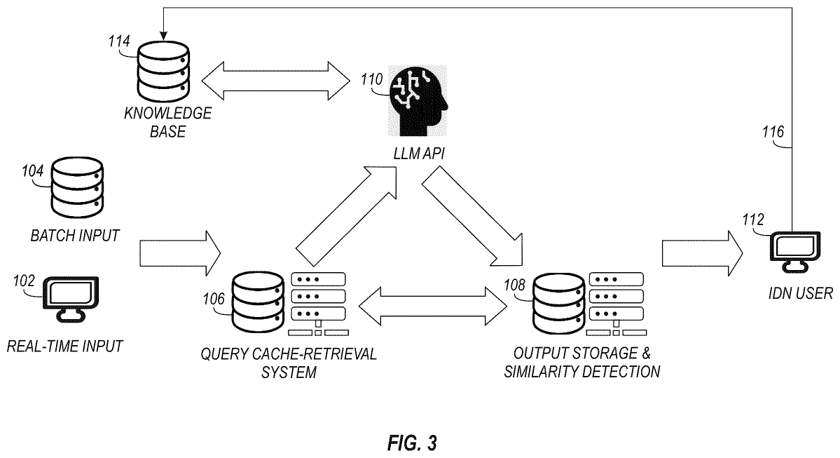

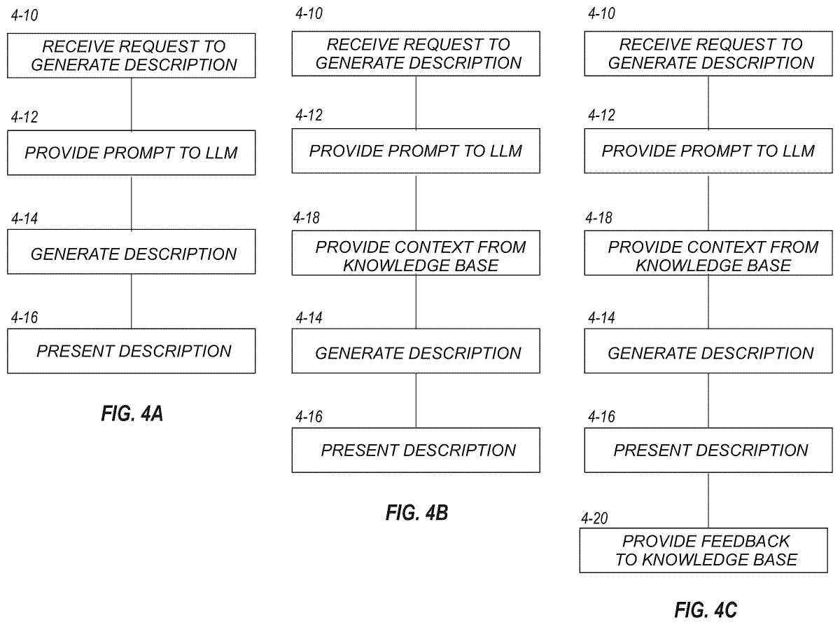

FIGS. 4A, 4B, and 4C are flowcharts depicting exemplary processes for the automated generation of access descriptions. FIG. 4A begins with step 4-10, where a request is received to generate a description(s) of an access entitlement. Referring to FIGS. 1-3, the request could come from a batch input (104) or from a user (102) providing real-time input via a user interface. At step 4-12, a prompt is provided to the LLM (110). In some embodiments, the prompt may include various information such as one or more rules for the LLM (110) to follow when generating the description for the access entitlement. At step 4-14, the LLM (110) generates a description based on the LLM's training, the prompt, and the request. The LLM (110) may also check the cache-retrieval system (106) for matching previously generated descriptions. At step 4-16, the generated description may be presented to a user (112) via a user interface. FIG. 4B is similar to FIG. 4A, with the additional step 4-18, where context is provided to the LLM (110) by the knowledge base (114). FIG. 4C is similar to FIG. 4B, with the additional step 4-20, where the user (112) provides feedback (116) to the knowledge base (114) to improve the LLM (110).

Aspects and implementations of the system and method of this disclosure have been described in the general context of various steps and operations. A variety of these steps and operations may be performed by hardware components or may be embodied in computer-executable instructions, which may be used to cause a general-purpose or special-purpose processor (e.g., in a computer, server, or other computing device) programmed with the instructions to perform the steps or operations. For example, the steps or operations may be performed by a combination of hardware, software, and/or firmware.

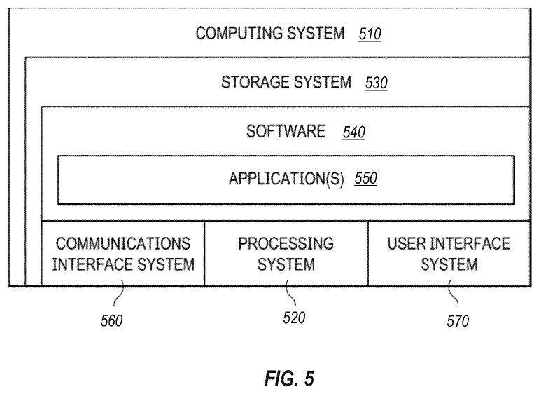

FIG. 5 illustrates computing system 510, which is representative of any system or collection of systems in which the various applications, services, scenarios, and processes disclosed herein may be implemented. For example, computing system 510 may include server computers, blade servers, rack servers, and any other type of computing system (or collection thereof) suitable for carrying out the enhanced collaboration operations described herein. Such systems may employ one or more virtual machines, containers, or any other type of virtual computing resource in the context of supporting enhanced group collaboration.

Computing system 510 may be implemented as a single apparatus, system, or device or may be implemented in a distributed manner as multiple apparatuses, systems, or devices. Computing system 510 includes, but is not limited to, processing system 520, storage system 530, software 540, applications 550, communication interface system 560, and user interface system 570. Processing system 520 is operatively coupled with storage system 530, communication interface system 560, and an optional user interface system 570.

Processing system 520 loads and executes software 540 from storage system 530. When executed by processing system 520 for deployment of scope-based certificates in multi-tenant cloud-based content and collaboration environments, software 540 directs processing system 520 to operate as described herein for at least the various processes, operational scenarios, and sequences discussed in the foregoing implementations. Computing system 510 may optionally include additional devices, features, or functionality not discussed for purposes of brevity.

Referring still to FIG. 5, processing system 520 may comprise a micro-processor and other circuitry that retrieves and executes software 540 from storage system 530. Processing system 520 may be implemented within a single processing device, but may also be distributed across multiple processing devices or sub-systems that cooperate in executing program instructions. Examples of processing system 520 include general purpose central processing units, application specific processors, and logic devices, as well as any other type of processing device, combinations, or variations thereof.

Storage system 530 may comprise any computer readable storage media readable by processing system 520 and capable of storing software 540. Storage system 530 may include volatile and nonvolatile, removable and non-removable media implemented in any method or technology for storage of information, such as computer readable instructions, data structures, program modules, or other data. Examples of storage media include random access memory, read only memory, magnetic disks, nonvolatile memory, battery backed memory, Non-Volatile DIMM memory, phase change memory, memristor memory, optical disks, flash memory, virtual memory and non-virtual memory, magnetic cassettes, magnetic tape, magnetic disk storage or other magnetic storage devices, or any other suitable storage media.

In addition to computer readable storage media, in some implementations storage system 530 may also include computer readable communication media over which at least some of software 540 may be communicated internally or externally. Storage system 530 may be implemented as a single storage device, but may also be implemented across multiple storage devices or sub-systems co-located or distributed relative to each other. Storage system 530 may comprise additional elements, such as a controller, capable of communicating with processing system 520 or possibly other systems.

Software 540 may be implemented in program instructions and among other functions may, when executed by processing system 520, direct processing system 520 to operate as described with respect to the various operational scenarios, sequences, and processes illustrated herein. For example, software 540 may include program instructions for directing the system to perform the processes described above.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 540 may include additional processes, programs, or components, such as operating system software, virtual machine software, or application software. Software 540 may also comprise firmware or some other form of machine-readable processing instructions executable by processing system 520.

In general, software 540 may, when loaded into processing system 520 and executed, transform a suitable apparatus, system, or device (of which computing system 510 is representative) overall from a general-purpose computing system into a special-purpose computing system. Indeed, encoding software on storage system 530 may transform the physical structure of storage system 530. The specific transformation of the physical structure may depend on various factors in different implementations of this description. Examples of such factors may include, but are not limited to, the technology used to implement the storage media of storage system 530 and whether the computer-storage media are characterized as primary or secondary storage, as well as other factors.

For example, if the computer readable storage media are implemented as semiconductor-based memory, software 540 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 560 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 570 may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 570. In some cases, the input and output devices may be combined in a single device, such as a display capable of displaying images and receiving touch gestures. The aforementioned user input and output devices are well known in the art and need not be discussed at length here. In some cases, the user interface system 570 may be omitted when the computing system 510 is implemented as one or more server computers such as, for example, blade servers, rack servers, or any other type of computing server system (or collection thereof).

User interface system 570 may also include associated user interface software executable by processing system 520 in support of the various user input and output devices discussed above. Separately or in conjunction with each other and other hardware and software elements, the user interface software and user interface devices may support a graphical user interface, a natural user interface, an artificial intelligence (AI) enhanced user interface that may include a virtual assistant or bot (for example), or any other type of user interface, in which a user interface to an imaging application may be presented.

Communication between computing system 510 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. In any of the aforementioned examples in which data, content, or any other type of information is exchanged, the exchange of information may occur in accordance with any of a variety of well-known data transfer protocols.

Although the invention has been described with respect to specific embodiments thereof, these embodiments are merely illustrative, and not restrictive of the invention as a whole. Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention.

Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Software implementing embodiments disclosed herein may be implemented in suitable computer-executable instructions that may reside on a computer-readable storage medium. Within this disclosure, the term “computer-readable storage medium” encompasses all types of data storage medium that can be read by a processor. Examples of computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, hosted or cloud-based storage, and other appropriate computer memories and data storage devices.

Those skilled in the relevant art will appreciate that the invention can be implemented or practiced with other computer system configurations including, without limitation, multi-processor systems, network devices, mini-computers, mainframe computers, data processors, and the like. The invention can be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks).

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention. At least portions of the functionalities or processes described herein can be implemented in suitable computer-executable instructions. The computer-executable instructions may reside on a computer readable medium, hardware circuitry or the like, or any combination thereof.

Any suitable programming language can be used to implement the routines, methods or programs of embodiments of the invention described herein, including C, C++, Java, JavaScript, HTML, or any other programming or scripting code, etc. Different programming techniques can be employed such as procedural or object oriented. Other software/hardware/network architectures may be used. Communications between computers implementing embodiments can be accomplished using any electronic, optical, radio frequency signals, or other suitable methods and tools of communication in compliance with known network protocols.

As one skilled in the art can appreciate, a computer program product implementing an embodiment disclosed herein may comprise a non-transitory computer readable medium storing computer instructions executable by one or more processors in a computing environment. The computer readable medium can be, by way of example only but not by limitation, an electronic, magnetic, optical or other machine readable medium. Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices.

Particular routines can execute on a single processor or multiple processors. Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. Functions, routines, methods, steps and operations described herein can be performed in hardware, software, firmware or any combination thereof.

It will also be appreciated that one or more of the elements depicted in the drawings/figures can be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited to only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the meaning of “in” includes “in” and “on” unless the context clearly dictates otherwise.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Generally then, although the invention has been described with respect to specific embodiments thereof, these embodiments are merely illustrative, and not restrictive of the invention. Rather, the description is intended to describe illustrative embodiments, features and functions in order to provide a person of ordinary skill in the art context to understand the invention without limiting the invention to any particularly described embodiment, feature or function, including any such embodiment feature or function described. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

What is claimed is:

1. An automated access description generation system, comprising:
a processor;
a non-transitory, computer-readable storage medium, including computer instructions for:
receiving a request to generate a description for an access entitlement in an identity governance and administration;
providing a prompt to a large language models (LLM), the prompt specifying one or more rules for the LLM to follow when generating the description for the access entitlement;
generating the description of the access entitlement using the LLM;
presenting, over a graphical user interface, the generated description of the access entitlement.

2. The system of claim 1, wherein the prompt provided to the LLM includes one or more of: a string identifier, a source of the entitlement, and roles of users who have access to the access entitlement.

3. The system of claim 1, wherein the computer instructions further comprise:
storing context information about specific entitlements in a knowledge base;
providing context information relating to the access entitlement stored in the knowledge base to the LLM.

4. The system of claim 3, wherein the context information relating to the access entitlement includes information about a specific organization.

5. The system of claim 3, wherein the context information relating to the access entitlement includes information about a specific industry.

6. The system of claim 3, wherein the computer instructions further comprise:
providing feedback from a reviewer of the description generated by the LLM to the knowledge base.

7. The system of claim 1, wherein the computer instructions further comprise:
fine-tuning the LLM using training data, the training data including a plurality of input/output pairs.

8. The system of claim 7, wherein the input/output pairs include training data including one or more of: an identifier of the entitlement, a source application of the entitlement, roles of users who have access to the entitlement, and activity data about usage of the entitlement.

9. An automated access description generation method, comprising:
receiving a request to generate a description for an access entitlement in an identity governance and administration;
providing a prompt to a large language models (LLM), the prompt specifying one or more rules for the LLM to follow when generating the description for the access entitlement;
generating the description of the access entitlement using the LLM;
presenting, over a graphical user interface, the generated description of the access entitlement.

10. The method of claim 9, wherein the prompt provided to the LLM includes one or more of: a string identifier, a source of the entitlement, and roles of users who have access to the access entitlement.

11. The method of claim 9, further comprising:
storing context information about specific entitlements in a knowledge base;
providing context information relating to the access entitlement stored in the knowledge base to the LLM.

12. The method of claim 11, wherein the context information relating to the access entitlement includes information about a specific organization.

13. The method of claim 11, wherein the context information relating to the access entitlement includes information about a specific industry.

14. The method of claim 11, further comprising:
providing feedback from a reviewer of the description generated by the LLM to the knowledge base.

15. The method of claim 9, further comprising:
fine-tuning the LLM using training data, the training data including a plurality of input/output pairs.

16. The method of claim 15, wherein the input/output pairs include training data including one or more of: an identifier of the entitlement, a source application of the entitlement, roles of users who have access to the entitlement, and activity data about usage of the entitlement.

17. A non-transitory computer readable medium, comprising instructions for:
receiving a request to generate a description for an access entitlement in an identity governance and administration;
providing a prompt to a large language models (LLM), the prompt specifying one or more rules for the LLM to follow when generating the description for the access entitlement;
generating the description of the access entitlement using the LLM;
presenting, over a graphical user interface, the generated description of the access entitlement.

18. The non-transitory computer readable medium of claim 17, wherein the prompt provided to the LLM includes one or more of: a string identifier, a source of the entitlement, and roles of users who have access to the access entitlement.

19. The non-transitory computer readable medium of claim 17, wherein the computer instructions further comprise:
storing context information about specific entitlements in a knowledge base;
providing context information relating to the access entitlement stored in the knowledge base to the LLM.

20. The non-transitory computer readable medium of claim 17, wherein the computer instructions further comprise:
fine-tuning the LLM using training data, the training data including a plurality of input/output pairs.
